(19) United States
(12) Patent Application Publication
(10) Pub. No.: US 2012/0226500 A1
(43) Pub. Date: Sep. 6, 2012

(54) SYSTEM AND METHOD FOR CONTENT RENDERING INCLUDING SYNTHETIC NARRATION

(75) Inventors: Guru Balasubramanian, San Diego, CA (US); Kalyana Srinivas Kota, San Diego, CA (US); Utkarsh Pandya, Jersey City, NJ (US)

(73) Assignee: SONY CORPORATION, Tokyo (JP)

(21) Appl. No.: 13/039,189

(22) Filed: Mar. 2, 2011

(51) Int. Cl. G10L 13/08

(52) U.S. Cl. 704/260; 704/E13.001

(57) ABSTRACT

A system and method for capturing a voice information and using the voice information to modulate a content output signal. The method for capturing voice information includes receiving a request to create speech modulation and presenting a piece of textual content operable for use in creating the speech modulation based on the textual input. The method further includes receiving a first voice sample and determining a voice fingerprint based on said first voice sample. The voice fingerprint is operable for modulating speech during content rendering (e.g., audio output) such that a synthetic narration is performed based on the textual input. The voice fingerprint may then be stored and used for modulating the output.

### FIELD OF THE INVENTION

Embodiments of the present invention are generally related to electronic devices and the narration of content, e.g., via an audio/video system.

### BACKGROUND OF THE INVENTION

As technology has advanced, computers have supported an increasing number of functions and an increasing number of types of content. As a result, a variety of ways to output content have been developed, such as text-to-speech functionality, etc. Text-to-speech functionality is particularly useful for those who cannot read and those with disabilities. In particular, text-to-speech functionality can be very useful for children who have not yet learned to read or are learning how to read. With increasing access to the internet, children are increasingly able to access a variety of content with ease.

Unfortunately, conventional text-to-speech output has undesirable properties, such as harsh and unpleasant machine-like sounds and is often monotone in nature. Such undesirable properties result in the voice of text-to-speech synthetic output being unfamiliar to a child listener. Further, text-to-speech output may not correctly pronounce words which may result in a child learning incorrect pronunciations.

Thus, the text-to-speech output, e.g., synthetic voice, has a variety of undesirable properties that can negatively impact the benefits of text-to-speech output when used by children.

### SUMMARY OF THE INVENTION

Thus, a need exists for text-to-speech output that is modulated to a familiar voice that facilitates children following along and learning. Embodiments of the present invention support the ability to record multiple samples of a person's voice, apply a voice recognition algorithm (e.g., KL transform) to generate a fingerprint of a person's voice, and then use that fingerprint to regenerate, through modulation, a narration that mimics the person's voice. This results in a synthetic narration experience similar to a story narrated by the child's parents or their favorite character, thereby making the narration both familiar and enjoyable. The resultant synthetic voice is therefore modeled after the familiar voice. Embodiments of the present invention are further language independent and therefore operable to work with a variety of languages. Embodiments of the present invention are operable to function as an “infotainment” portal for children at bedtime.

In one embodiment, the present invention is implemented as a method for capturing voice information and using the voice information to modulate a content output signal. The method includes receiving a request to create the speech modulation and presenting a piece of content operable for use in creating the speech modulation. The method further includes receiving a first voice sample and determining a voice fingerprint based on the first voice sample. The voice fingerprint is operable for modulating speech during content rendering (e.g., synthetic narration). The determination of the voice fingerprint may be based on a transform of the first voice sample. The voice fingerprint may then be stored and used for modulating output of content. Embodiments of the present invention also allow configuration of the voice fingerprint for various accents and the method may further include receiving a request to modify a voice fingerprint for a specific word and receiving a second voice sample corresponding to the specific word.

The method may further include receiving a selection of a voice modulation corresponding to the voice fingerprint (e.g., prior to rendering content). The method can further include accessing a portion of content and accessing the voice fingerprint. The portion of content is then rendered (e.g., output as audio) based on a modulation of the content that is based on the voice fingerprint. The rendering of the portion of the content can include highlighting a word of the portion of content. The content may be rendered with the display of a content rendering control button which is operable for user control of the content rendering (e.g., stop, pause, play, fast forward). In one embodiment, the method may further allow selection of content and include receiving a request comprising a selection of the portion of content and presenting an on-screen menu comprising a list of a plurality of functions related to the portion of content.

In one embodiment, the present invention is implemented as a system for content presentation. The system includes a voice fingerprint determination module operable for determining a voice fingerprint based on a voice sample and a sample presentation module operable for presenting a sample of a portion of content operable for use in creating the voice fingerprint. In one embodiment, the voice fingerprint determination module is operable to determine the voice fingerprint based on a transformation of the voice sample. The voice fingerprint determination module is further operable to allow the voice fingerprint to reflect an accent of the voice sample. The system further includes a content access module operable to access content and select a portion of the content for rendering and a modulation module operable to render the portion of the content based on modulating the voice fingerprint. The system may further include a content presentation module and a function presentation module. The content presentation module is operable to present the portion of content on a display and operable to highlight a portion of the content based on a rendering of the portion of content by the modulation module. The content presentation module is further operable to present one or more content rendering control buttons for controlling content rendering. In one embodiment, the function presentation module is operable to present a list of functions associated with the portion of content.

In another embodiment, the present invention is implemented as a computer readable media comprising instructions that when executed by an electronic system implement a method for capturing voice information and using the voice information to modulate content output. The method includes receiving a request to create speech modulation and presenting a piece of content operable for use in creating the speech modulation. The method further includes receiving a first voice sample and determining a voice fingerprint based on the first voice sample. The voice fingerprint is operable for modulating speech during content rendering (e.g., synthetic narration). The determination of the voice fingerprint may be based on a transform of the first voice sample. The voice fingerprint may then be electronically stored and used for modulating output of content. Embodiments of the present invention allow configuration of the voice fingerprint for accents and the method may further include receiving a request to modify a voice fingerprint for a specific word, e.g., an irregular pronunciation, and receiving a second voice sample corresponding to the specific word.

The method may further include receiving a selection of a voice modulation corresponding to the voice fingerprint (e.g., prior to rendering content). The method can further include accessing a portion of content and accessing the voice fingerprint. The portion of content can then be rendered (e.g., output as audio) based on a modulation of the content based on the voice fingerprint. The rendering of the portion of content can comprise highlighting a word of the portion of content. The content may be rendered with the display of a content rendering control button that is operable for controlling the rendering of the content (e.g., stop, pause, play, fast forward). In one embodiment, the method may further allow selection of content and include receiving a request comprising a selection of the portion of content and presenting an on-screen menu comprising a list of a plurality of functions related to the portion of content.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows a diagram of an exemplary electronic device in accordance with one embodiment of the present invention.

FIG. 2A shows a diagram of an exemplary on-screen display area in accordance with one embodiment of the present invention.

FIG. 2B shows a diagram of an exemplary dual pane screen display area in accordance with one embodiment of the present invention.

FIG. 3 shows a flowchart of an exemplary computer controlled process for capturing a voice fingerprint in accordance with one embodiment of the present invention.

FIG. 4 shows a flowchart of an exemplary computer controlled process for rendering content in accordance with one embodiment of the present invention.

FIG. 5 shows exemplary components of an audio/video device in accordance with one embodiment of the present invention.

FIG. 6 shows exemplary components of an operating environment for rendering content in accordance with one embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

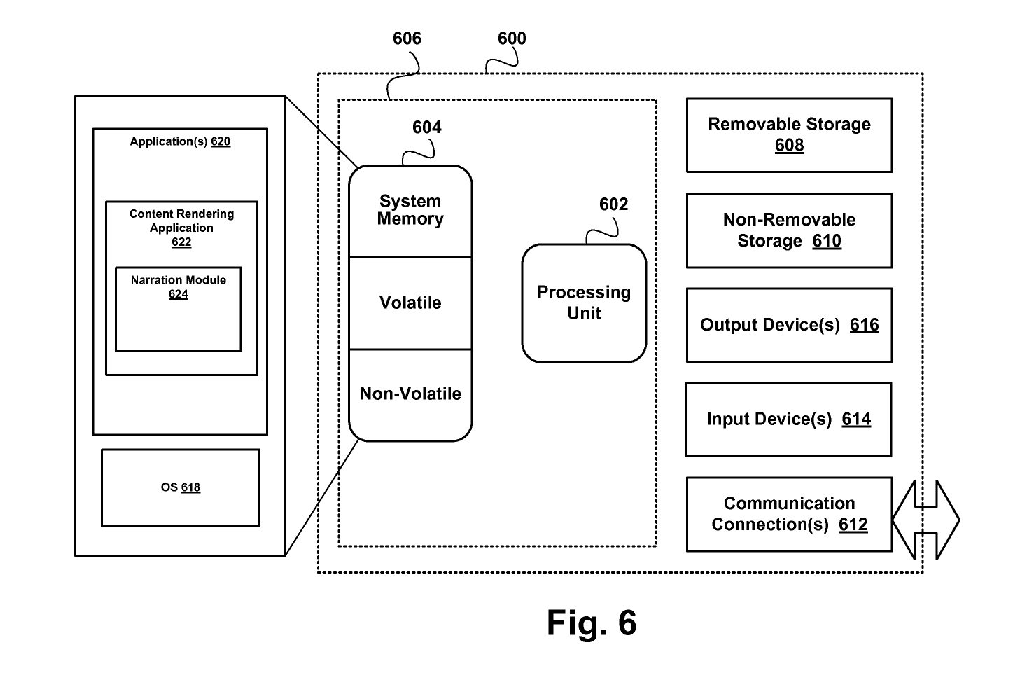

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a system having computing functionality (e.g., system 600 of FIG. 6), or similar electronic computing device, that manipulates and transforms data represented as physical (electronic) quantities within the computer system's registers and memories into other data similarly represented as physical quantities within the computer system memories or registers or other such information storage, transmission or display devices.

### Exemplary Systems and Methods for Content Narration

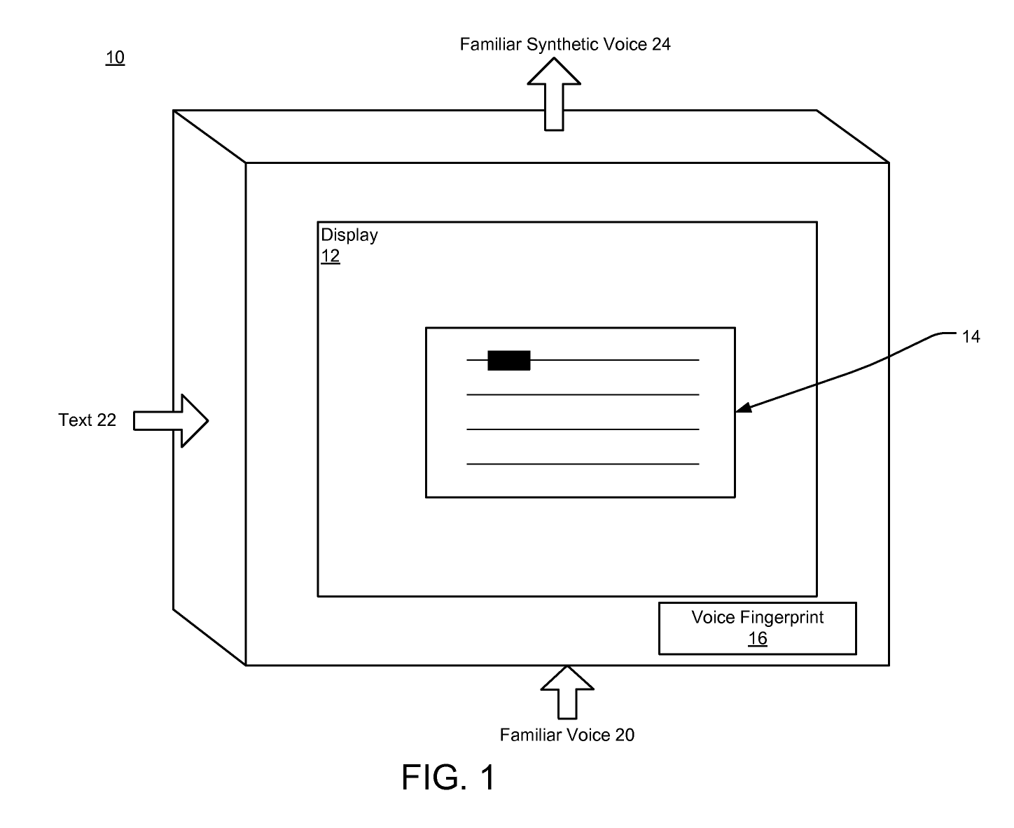

FIG. 1 shows a diagram of an exemplary electronic device in accordance with one embodiment of the present invention. Generally speaking, device 10 is operable to receive or access text 22 and outputs familiar synthetic voice 24 which is based on familiar voice 20. For example, familiar voice 20 may be the voice of a parent and thus be familiar to a child. Synthetic voice 24 is a synthetic narration based on the text 22.

Device 10 includes display 12 which is operable to display a variety of content, as described below. Display 12 is also operable to display text area 14 which displays text 22. Device 10 is operable to receive familiar voice 20 which is a voice signal based on a user (e.g., parent) reading out loud of a training or sample piece of content. Device 10 then determines voice fingerprint 16 based on familiar voice 20.

Device 10 receives or accesses stored text 22 and output familiar synthetic voice 24 based on text-to-speech functionality which modulates audio output of text 22 based on voice fingerprint 16. In one embodiment, as a portion of text 22 is output as familiar synthetic voice 24, the corresponding portion of text 22 is contemporaneously highlighted in text area 14. Thus, device 10 outputs familiar synthetic voice 24 which is familiar to a child and highlights the corresponding portion which facilitates a child learning to read.

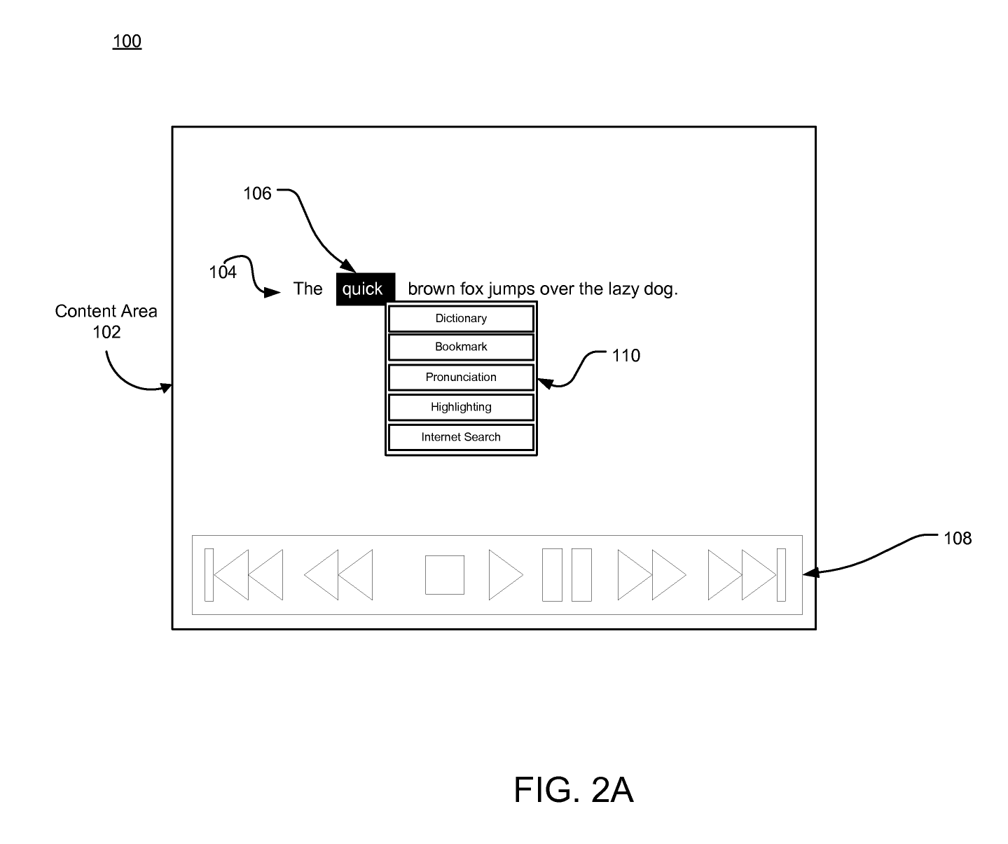

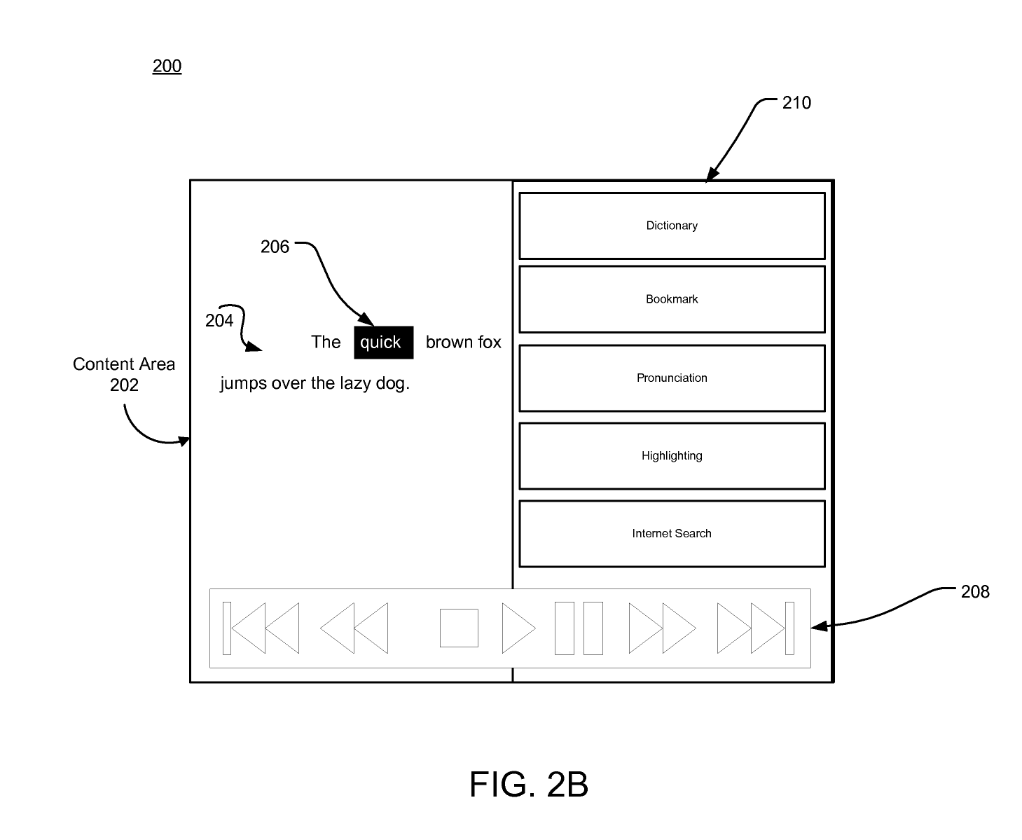

FIG. 2A shows a diagram of an exemplary screen display area in accordance with one embodiment of the present invention. Exemplary display area 100 resides on a media display, e.g., a television display, computer display, tablet display, and includes content area 102 which includes rendering control area 108. Embodiments of the present invention allow content to be rendered (e.g., displayed, output as audio, and the like) wherein a portion of content is output via an audio signaling having a modulation based on a voice fingerprint. Embodiments of the present invention further allow the portion of content being output via an audio output to be contemporaneously indicated in content area 102 thereby allowing a user (e.g., a child) to follow along and learn how to pronounce the words.

Rendering control area 108 includes on-screen controls (e.g., on-screen buttons) for controlling content rendering. In one embodiment, rendering control area 108 includes well known controls such as pause, play, stop, rewind, fast-forward, next piece of content, previous piece of content buttons and volume control (not shown). For example, next piece of content and previous piece of content buttons may allow a selection of the next and previous electronic book files contained in a playlist or library or allow a user to navigate pages, paragraphs, or chapters of content.

Content area 102 is operable for displaying content 104 which may include text from a variety of sources including an electronic book (e.g., purchased or downloaded from any of a variety of online retailer or websites), a webpage, text file, Portable Document Format (PDF) file, and the like. As content 104 is output as modulated audio based on a voice fingerprint, as described herein, and the word or portion of content being presently output is marked with display highlighting 106. Highlighting 106 allows a user (e.g., child) to follow along to facilitate learning the word (e.g., via association of the highlighted word and the audio output of that word).

Embodiments of the present invention further allow a user to invoke various functions associated with a portion of content (e.g., word). A user may tap or select a word upon which menu 110 is displayed. In one exemplary embodiment, menu 110 allows a user to invoke a dictionary function, bookmark function, pronunciation function, highlighting function, or Internet search function. The dictionary function may display a definition of the word from a dictionary (e.g., local or Internet dictionary) and then output an audio signal of the definition provided by the dictionary (e.g., a modulation based on a voice fingerprint). The bookmark function may allow a user to save the location in the content so that the same location in the content may be accessed at a later point in time. The pronunciation function may display the word with a pronunciation guide (e.g., with pronunciation indicators). The highlighting function allows a user to enable or disable highlighting and also configure highlighting (e.g., color, size, shape of highlighting area, animation effect, etc.). The internet search function may allow a user to launch a web browser to a variety of sites, for instance, a search engine, dictionary, thesaurus, and the like.

FIG. 2B shows a diagram of an exemplary dual pane screen display area in accordance with one embodiment of the present invention. Exemplary display area 200 resides on a media display, e.g., a television display, computer display, tablet display, and includes content area 202 which includes rendering control area 208. Display area 200 is split vertically with content (e.g., content 204) displayed on a left portion of the screen and functions associated with the portion of the content displayed in menu 210. It is appreciated that embodiments of the present invention also support a horizontal split display of the content and associated functions.

Rendering control area 208 comprises controls (e.g., on-screen buttons) for controlling content rendering, for instance, well known control buttons mentioned above. The functions of menu 210 can be a number of well known controls. In one embodiment, menu 210 can be a number of well known controls. Menu 210 may be substantially similar to menu 110 and may displayed without requiring user input.

Content area 202 is operable to display content 204 which may include text from a variety of sources, as described above. As content 204 is output as modulated audio based on a voice fingerprint, as described herein, the corresponding portion of content 204 is contemporaneously marked with highlighting 206. Highlighting 206 allows a user (e.g., child) to follow along to facilitate learning the word (e.g., via association of the highlighted word and the audio output of that word).

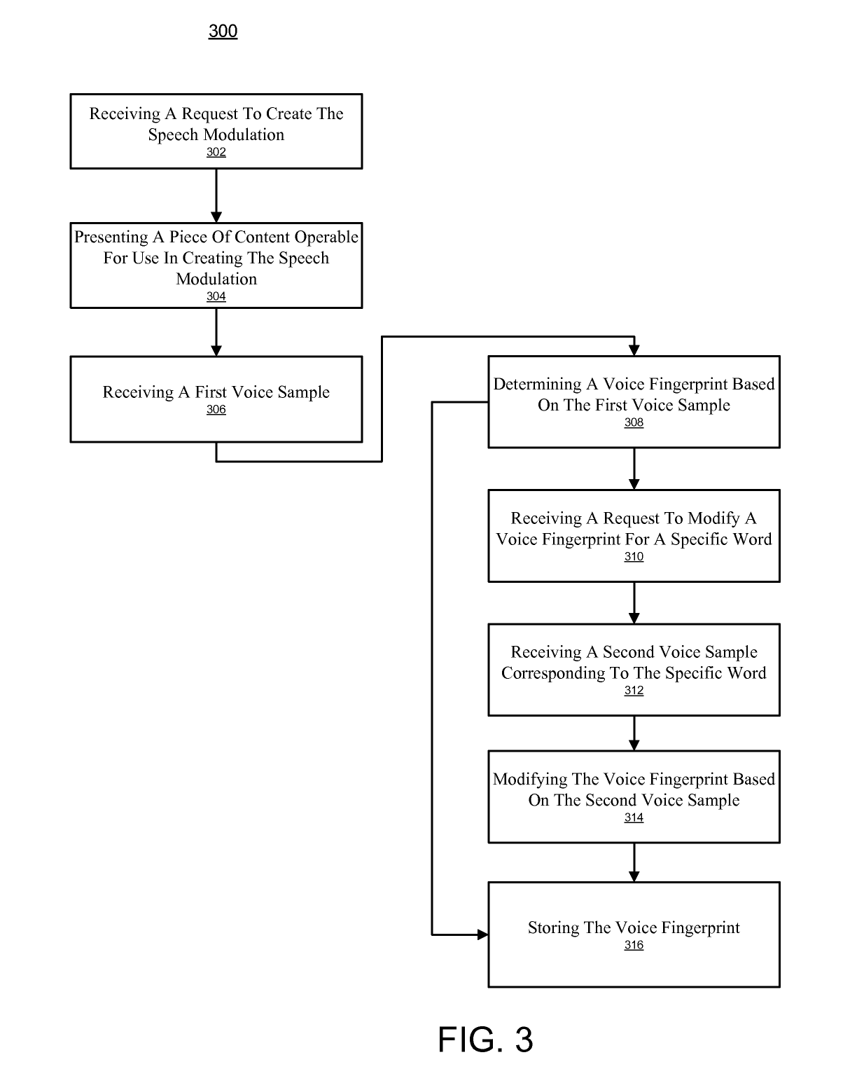

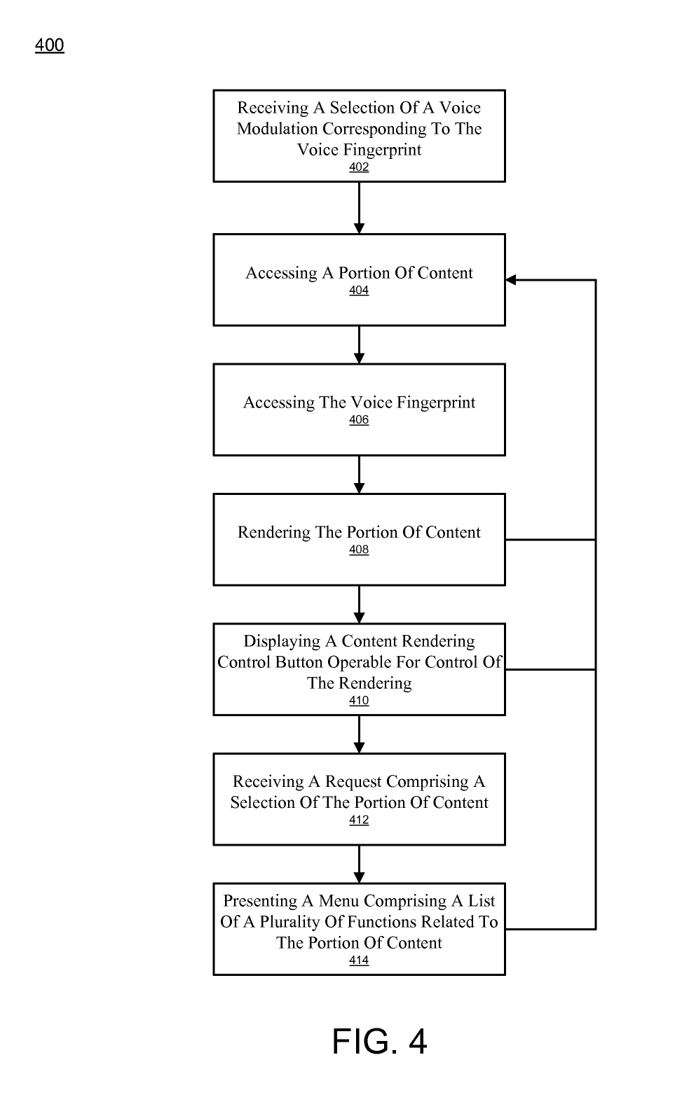

With reference to FIGS. 3-4, flowcharts 300-400 illustrate example functions used by various embodiments of the present invention. Flowcharts 300-400 include processes that, in various embodiments, are carried out by one or more processors under the control of computer-readable and computer-executable instructions which may be stored on a computer-readable medium. Although specific function blocks (“blocks”) are disclosed in flowcharts 300-400, such steps are examples. That is, embodiments are well suited to performing various other blocks or variations of the blocks recited in flowcharts 300-400. It is appreciated that the blocks in flowcharts 300-400 may be performed in an order different than presented, and that not all of the blocks in flowcharts 300-400 may be performed.

FIG. 3 shows a flowchart of an exemplary computer controlled process for generating a voice fingerprint in accordance with one embodiment of the present invention. Process 300 facilitates storing of a voice fingerprint which is operable for modulating output of content (e.g., in a voice familiar to a child).

At block 302, a request to create a speech modulation is received. The request may be initiated via a modulation configuration application or a content rendering application (e.g., content rendering application 622).

At block 304, a piece of content operable for use in creating the speech modulation is presented. For example, sample content (e.g., a short story, a famous speech, etc.) for use in capturing a voice sample signal is presented.

At block 306, a first voice sample is received. The first voice sample may be received via a microphone or other recording device. The voice sample may be based on a set of training words or phrases displayed to the speaker and asked to repeat.

At block 308, a voice fingerprint is determined based on the first voice sample. In one embodiment, the determination of the voice fingerprint is based on a transform of the first voice sample (e.g., transform of tone and amplitude of the voice sample). It is appreciated that a variety of transforms can be used including a Karhunen-Loève (KL) transform. Block 316 may then be performed wherein the voice fingerprint is electronically stored.

At block 310, a request to modify a voice fingerprint for a specific word is received. For example, a user (e.g., parent) may wish to modify the voice fingerprint to reflect an accent.

At block 312, a second voice sample corresponding to the specific word is received. The second voice sample may be received via a microphone or other recording device.

At block 314, the voice fingerprint is modified based on the second voice sample. For example, the voice fingerprint may be updated such that modulations of the voice fingerprint reflect the second voice sample and thereby the accent of a user (e.g., parent).

At block 316, the voice fingerprint is electronically stored. The voice fingerprint is stored for use in modulating speech output during content rendering (e.g., narration).

FIG. 4 shows a flowchart of an exemplary computer controlled process for rendering content in accordance with one embodiment of the present invention using a generated voice fingerprint. Process 400 allows rendering of content modulated based a voice fingerprint (e.g., determined based on a voice sample). Embodiments of the present invention also support preconfigured voice fingerprints (e.g., downloaded or purchased from the Internet).

At block 402, a selection of a voice modulation corresponding to a voice fingerprint is received. In one embodiment, the voice fingerprint may be downloaded and the voice fingerprint may correspond to a character (e.g., a television show character, a radio show character, a comic book character, a movie character, and the like). Selection of the modulation may be received after presentation of a list of different modulations corresponding to different familiar voices. In one embodiment, a user may be able to select a voice modulation and then rendering of the content is automatically performed. For example, a parent may select a modulation based on a sample of his or her voice then a bedtime story may be automatically output based on the parent's voice.

At block 404, a portion of the textual content is accessed. For example, a portion of the content including text to be displayed on a display screen is accessed. It is appreciated that pictures and video may also be displayed contemporaneously.

At block 406, the voice fingerprint is accessed. The voice fingerprint corresponds to the modulation previously selected.

At block 408, the portion of content is rendered via an audio output that is modulated based on the voice fingerprint. In one embodiment, the rendering of the portion of content comprises contemporaneously highlighting the word being output as audio (e.g., on screen). Block 404 may then be performed as the next portion of content is accessed.

At block 410, an on-screen content rendering control button operable for control of the rendering is displayed. The control button may allow navigation of the textual content (e.g., next page, paragraph, or chapter) and allows control of content rendering (e.g., stop, play, fast forward), as described herein. Block 404 may then be performed as the next portion of content is accessed.

At block 412, a request comprising a selection of the portion of content is received. In one embodiment, selection may be based on a user tapping a displayed word or a portion of content.

At block 414, on-screen menu comprising a list of a plurality of functions related to the portion of content is presented. Embodiments of the present invention support a variety of functions (e.g., dictionary, bookmark, pronunciation, highlighting, and internet search), as described herein. Block 404 may then be performed as the next portion of content is accessed.

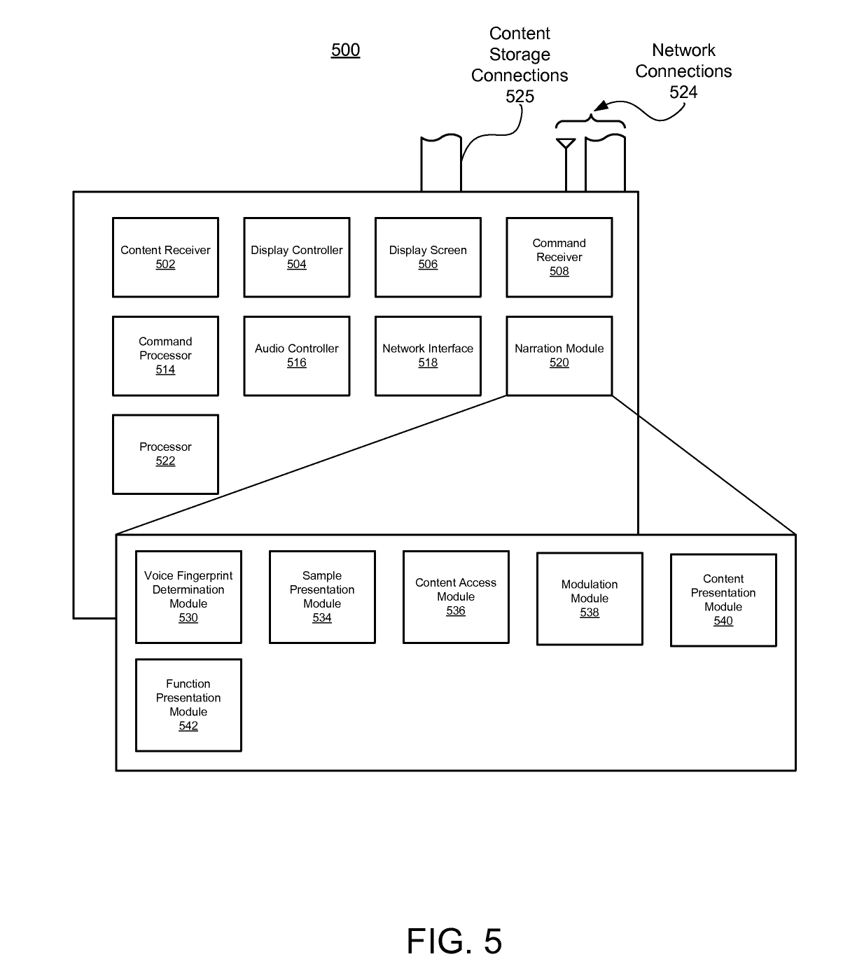

FIG. 5 illustrates exemplary components used by various embodiments of the present invention within an electronic device. Although specific components are disclosed in system 500, it should be appreciated that such components are examples. That is, embodiments of the present invention are well suited to having various other components or variations of the components recited in system 500. It is appreciated that the components in system 500 may operate with other components than other those presented, and that not all of the components of system 500 may be required to achieve the goals of system 500.

FIG. 5 shows exemplary components of an audio/video device for synthetic narration based on a familiar voice in accordance with one embodiment of the present invention. System 500 includes content receiver 502, display controller 504, display screen 506, command receiver 508, command processor 514, audio controller 516, network interface 518, narration module 520, and processor 522. Processor 522 is operable to execute or otherwise carryout functions of components of system 500.

In one exemplary embodiment, system 500 may be a tablet or small form factor computing system. System 500 may be sized such that system 500 can occupy a bedside location, for instance. System 500 may be operable to perform a variety of functions including alarm clock functionality, internet radio player, digital photo frame, and the like. Embodiments of the present invention are operable to function as an infotainment portal for children at bedtime.

Content receiver 502 is operable to receive content (including textual signals) via content connections 526 and network connections 524 (e.g., wired or wireless computer network via network interface 518) for system 500. Network connections 524 may operable to work with a variety of communication standards including Ethernet, Bluetooth, Wi-Fi, General Packet Radio Service (GPRS), Edge, High-Speed Downlink Packet Access (HSDPA), etc. Content receiver 502 may receive signals including content from a variety of sources including, but not limited to, computers, computer networks, portable devices, electronic book (e-book) devices, set top boxes, over the air broadcasts, cable broadcasts, satellite broadcasts, Digital versatile Discs (DVDs), Blu-ray discs, Digital Video Broadcasting-Handheld (DVB-H), Digital Multimedia Broadcasting (DMB), Digital Video Broadcasting Satellite services to Handhelds (DVB-SH), Digital Audio Broadcasting (DAB), Digital Video Broadcasting IP Datacasting (DVB-IPDC), Internet Protocol Television (IPTV), etc. Content receiver 502 may also receive electronic programming guide information. Content connections 526 may include a variety of connection types including HDMI (High-Definition Multimedia Interface), DisplayPort, DVI (Digital Visual Interface), VGA (Video Graphics Array), S-video, component, composite, SCART (Syndicat des Constructeurs d'Appareils Radiorécepteurs et Téléviseurs), cable, and satellite, etc.

In various embodiments, content may be available from a website or an online retailer (e.g., from Amazon.com, Inc. of Seattle, Wash.), via sharing of a previously purchased or downloaded e-book (e.g., through wireless transfer from a computing system or a Sony eReader, available from Sony Corporation of Tokyo, Japan), or from a storage device (e.g., Universal Serial Bus (USB) device containing a copy of an e-book). Further, content may be any source from which text can be extracted or parsed from (e.g., via Optical character recognition (OCR)).

Display controller 504 controls display screen 506 of system 500. Display controller 504 may control a variety of display screens types associated with system 500, including CRTs (cathode ray tubes), LCDs (liquid crystal display), plasma displays, projection based, and DLP (digital light processing) displays, touchscreen displays (e.g., capacitive touchscreen displays), etc. In one embodiment, display screen 506 may be turned on or off during content narration. In one exemplary embodiment, if the screen is on during narration, the word being rendered via modulation of the voice fingerprint may be contemporaneously highlighted. This indicates a child the word being output and the associated pronunciation thus adding to the learning experience.

Command receiver 508 receives control commands for system 500. Command receiver 508 may receive commands via a variety of technologies including touchscreen, an optical receiver, and radio frequency. In one embodiment, the commands may have been issued via a remote control device (not shown). Command receiver 508 is operable to send the commands to command processor 514 for processing.

Command processor 514 processes commands received from command receiver 508. For example, command received via a touchscreen may be received by command processor 514 and sent to narration module 520. Control codes (e.g., increase volume, change channel, EPG selection, launch an application, launch web browser, etc.) may also be received by via an infrared receiver or radio frequency receiver, decoded, processed by command processor 514 or sent to narration module 520 for processing.

Synthetic narration module 520 includes voice fingerprint determination module 530, sample presentation module 534, content access module 536, modulation module 538, content presentation module 540, and function presentation module 542. Voice fingerprint determination module 530 is operable for determining a voice fingerprint based on a voice sample (e.g., via a microphone (not shown)), as described herein. In one embodiment, voice fingerprint determination module 530 is operable to determine the voice fingerprint based on a transformation of the voice sample. Voice fingerprint determination module 530 is further operable to determine or modify the voice fingerprint to reflect an accent of the voice sample, as described.

Sample presentation module 534 is operable for presenting a sample of portion of content operable for use in creating the voice fingerprint, as described herein. Content access module 536 is operable to access content and select a portion of the content for rendering, as described herein. Modulation module 538 is operable to render the portion of content based on modulating the voice fingerprint, as described herein. Function presentation module 542 is operable to present an on-screen list of functions associated with the portion of content, as described herein.

Content presentation module 540 is operable to present an on-screen portion of content, as described herein. Content presentation module 540 is further operable to highlight a portion of the content that is contemporaneously rendered by the modulation module 538. In one embodiment, content presentation module 540 is further operable to present an on-screen content rendering control button for controlling rendering of content, as described herein.

Audio controller 516 controls audio output for system 500 including a variety of outputs including, but not limited to, 2, 2.1, 3.1, 5.1, 6.1, 7.1, and 8.1 channel audio (e.g., via speakers (not shown)). The audio content may be sent from narration module 520. It is appreciated that audio controller 516 may output to audio equipment integrated within system 500.

FIG. 6 shows exemplary components of an operating environment for rendering content in accordance with one embodiment of the present invention. An exemplary system for implementing embodiments includes a general purpose computing system environment, such as computing system environment 600. Computing system environment 600 may include, but is not limited to a server, desktop computer, laptop, netbook, tablet PC, mobile device, or smartphone. In its most basic configuration, computing system environment 600 typically includes at least one processing unit 602 and memory 604. Depending on the exact configuration and type of computing system environment, memory 604 may be volatile (such as RAM), non-volatile (such as ROM, flash memory, etc.) or some combination of the two.

System memory 604 may include, among other things, Operating System 618 (OS), application(s) 620, and content rendering application 622. Content rendering application 622 is operable to render content (e.g., internet content, documents, text, electronic books and the like). Content rendering application 622 includes narration module 624 which outputs content that is modulated based on a stored voice fingerprint and may also indicate the portion of content being output (e.g., via highlighting), as described herein. Narration module 624 is further operable to allow selection of a word or words being output and present a corresponding menu with additional functions that can be invoked.

Additionally, computing system environment 600 may also have additional features/functionality. For example, computing system environment 600 may also include additional storage (removable and/or non-removable) including, but not limited to, magnetic or optical disks or tape. Such additional storage is illustrated in FIG. 1 by removable storage 608 and non-removable storage 610. Computer storage media includes volatile and nonvolatile, removable and non-removable media implemented in any method or technology for storage of information such as computer readable instructions, data structures, program modules or other data. Memory 604, removable storage 608 and nonremovable storage 610 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 600. Any such computer storage media may be part of computing system environment 600.

Computing system environment 600 may also contain communications connection(s) 612 that allow it to communicate with other devices. Communications connection(s) 612 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Communications connection(s) 612 may allow computing system environment 600 to communication over various networks types including, but not limited to, Bluetooth, Ethernet, Wi-Fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 612 connect to may run a plurality of network protocols including, but not limited to, transmission control protocol (TCP), internet protocol (IP), real-time transport protocol (RTP), real-time transport control protocol (RTCP), file transfer protocol (FTP), and hypertext transfer protocol (HTTP).

Computing system environment 600 may also have input device(s) 614 such as a keyboard, mouse, pen, voice input device, touch input device, remote control, etc. Output device(s) 616 such as a display, speakers, etc. may also be included. All these devices are well known in the art and need not be discussed at length here.

Embodiments of the present invention support the ability to record multiple samples of a person's voice, apply a voice recognition algorithm (e.g., KL transform) to generate a voice fingerprint of a person's voice, and then use that voice fingerprint to regenerate, through modulation, a synthetic narration that mimics the person's voice. This results in a synthetic narration experience similar to a story narrated by the child's parents or their favorite character, thereby making the narration both familiar and enjoyable. The resultant synthetic voice is therefore modeled after the familiar voice. Embodiments of the present invention are further language independent and therefore are operable to work with a variety of languages. Embodiments of the present invention are operable to function as an “infotainment” portal for children at bedtime.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A media device implemented method for capturing voice information comprising:
receiving a request to create speech modulation;
presenting a piece of content operable for use in creating said speech modulation;
receiving a first voice sample;
determining a voice fingerprint based on said first voice sample; and
storing said voice fingerprint, wherein said voice fingerprint is operable for modulating speech during content rendering wherein a piece of content is rendered in accordance with said voice fingerprint.

2. The method of claim 1 further comprising:
receiving a selection of a voice modulation corresponding to said voice fingerprint from a plurality of voice fingerprints.

3. The method of claim 1 further comprising:
accessing a portion of said piece of content;
accessing said voice fingerprint; and
rendering said portion based on a modulation of said content based on said voice fingerprint.

4. The method of claim 3 wherein said rendering of said portion comprises contemporaneously highlighting a word of said portion of content.

5. The method of claim 1 further comprising:
receiving a request comprising a selection of said piece of content; and
presenting a on-screen menu comprising a list of a plurality of functions related to said piece of content.

6. The method of claim 1 further comprising:
receiving a request to modify a voice fingerprint for a specific word;
receiving a second voice sample corresponding to said specific word; and
modifying said voice fingerprint based on said second sample.

7. The method of claim 3 further comprising:
displaying a content rendering control button operable for user control of content rendering.

8. The method of claim 1 wherein said determining said voice fingerprint is based on a transform of said first voice sample.

9. A system for content presentation comprising:
a voice fingerprint determination module operable for determining a voice fingerprint based on a voice sample;
a sample presentation module operable for presenting a sample of a portion of content operable for use in creating said voice fingerprint;
a content access module operable to access content and select a portion of said content for audio rendering;
a modulation module operable to audibly render said portion of content based on modulation based on said voice fingerprint.

10. A system as described in claim 9 further comprising:
a content presentation module operable to display said portion of content and operable to highlight content based on a contemporaneous rendering of said content by said modulation module.

11. A system as described in claim 10 wherein said content presentation module is further operable to display a control button for user control of content rendering.

12. A system as described in claim 9 further comprising:
a function presentation module operable to display a list of functions associated with said portion of content.

13. A system as described in claim 9 wherein said voice fingerprint determination module is operable to determine said voice fingerprint based on a transform of said voice sample.

14. A system as described in claim 9 wherein said voice fingerprint determination module is further operable to allow said voice fingerprint to reflect an accent of said voice sample.

15. A computer readable media comprising instructions that when executed by an electronic system implement a method for generating voice information, said method comprising:
receiving a request to create speech modulation;
presenting content operable for use in creating said speech modulation;
receiving a first voice sample;
determining a voice fingerprint based on said first voice sample; and
storing said voice fingerprint, wherein said voice fingerprint is operable for modulating speech during content rendering.

16. The computer readable media of claim 15 wherein said method further comprises:
receiving a selection of a voice modulation corresponding to said voice fingerprint from a plurality of voice fingerprints.

17. The computer readable media of claim 15 wherein said method further comprises
accessing a portion of said content;
accessing said voice fingerprint; and
rendering said portion of content based on a modulation of said portion of content based on said voice fingerprint.

18. The computer readable media of claim 17 said rendering said portion of content comprises highlighting a word of said portion of content.

19. The computer readable media of claim 15 wherein said method further comprises:
receiving a request to modify a voice fingerprint for a specific word;
receiving a second voice sample corresponding to said specific word; and
modifying said voice fingerprint based on said second sample.

20. The computer readable media of claim 17 wherein said method further comprises:
receiving a request comprising a selection of said portion of said content; and
presenting an on-screen menu comprising a list of a plurality of functions related to said selection of said portion of said content.
